(19) United States
(12) Patent Application Publication
(10) Pub. No.: US 2025/0334316 A1
(43) Pub. Date: Oct. 30, 2025

(54) TEMPERATURE-CONTROLLED FOODSERVICE UNIT

(71) Applicant: Thermodyne Food Service Products, Inc., Fort Wayne, IN (US)

(72) Inventors: David C. Schenkel, Fort Wayne, IN (US); Mark Blasi, Fort Wayne, IN (US); Tim P. Tippmann, New Haven, IN (US)

(73) Assignee: Thermodyne Food Service Products, Inc., Fort Wayne, IN (US)

(21) Appl. No.: 18/647,700

(22) Filed: Apr. 26, 2024

(51) Int. Cl. F25D 11/00; A47J 39/00; A47J 39/02; F25D 17/06; F25D 25/02; F25D 31/00

(52) U.S. Cl. CPC F25D 11/003; A47J 39/003; A47J 39/02; F25D 17/06; F25D 25/028; F25D 31/005; A47J 2202/00; F25D 2700/12

(57) ABSTRACT

A temperature-controlled foodservice unit includes: a body including a frame and defining a chamber; and a plurality of temperature-controlled systems operatively coupled with the frame and configured for transferring heat with respect to a food product positioned within the chamber, the plurality of temperature-controlled systems including: a temperature-controlled shelf system including at least one shelf and at least one fluid passageway, the at least one shelf being positioned within the chamber, the at least one fluid passageway being associated with the at least one shelf and configured for carrying a fluid therein so as to transfer heat by thermal conduction and thermal radiation with respect to the food product positioned on the at least one shelf; and a temperature-controlled air system configured for moving air through the chamber so as to transfer heat by thermal convection with respect to the food product positioned on the at least one shelf.

### BACKGROUND OF THE INVENTION

### 1. Field of the Invention

The present invention relates to foodservice units, and, more particularly, to

foodservice units with temperature control.

### 2. Description of the Related Art

A temperature-controlled foodservice unit can be formed as cabinet on wheels. The cabinet can include a plurality of shelves which are positioned within an interior chamber of the cabinet. Food product held by these shelves can be chilled or warmed by way of fluid shelf technology of the temperature-controlled foodservice unit, wherein refrigerated or warmed fluid is pumped through the shelves. Though such a unit is effective, an enhanced heat transfer with respect to the food product may be desirable.

Also known are foodservice units that employ only convection to cook food. An example of such a unit is an air fryer.

What is needed in the art is to improve the heat transfer of a temperature-controlled foodservice unit with respect to food product housed therein.

### SUMMARY OF THE INVENTION

The present invention provides a temperature-controlled foodservice unit that includes a temperature-controlled shelf system which employs thermal conduction and thermal radiation to transfer heat with respect to a food product within the unit, as well as a temperature-controlled air system which employs thermal convection to transfer heat with respect to the food product within the unit.

The invention in one form is directed to a temperature-controlled foodservice unit, which includes: a body including a frame and defining a chamber; and a plurality of temperature-controlled systems operatively coupled with the frame and configured for transferring heat with respect to a food product positioned within the chamber, the plurality of temperature-controlled systems including: a temperature-controlled shelf system including at least one shelf and at least one fluid passageway, the at least one shelf being positioned within the chamber, the at least one fluid passageway being associated with the at least one shelf and configured for carrying a fluid therein so as to transfer heat by thermal conduction and thermal radiation with respect to the food product positioned on the at least one shelf; and a temperature-controlled air system configured for moving air through the chamber so as to transfer heat by thermal convection with respect to the food product positioned on the at least one shelf.

The invention in another form is directed to a method of using a temperature-controlled foodservice unit, the method including the steps of: providing that the temperature-controlled foodservice unit includes a body and a plurality of temperature-controlled systems, the body including a frame and defining a chamber, the plurality of temperature-controlled systems being operatively coupled with the frame and configured for transferring heat with respect to a food product positioned within the chamber, the plurality of temperature-controlled systems including a temperature-controlled shelf system and a temperature-controlled air system, the temperature-controlled shelf system including at least one shelf and at least one fluid passageway, the at least one shelf being positioned within the chamber, the at least one fluid passageway being associated with the at least one shelf; carrying, by the at least one fluid passageway, a fluid in the at least one fluid passageway so as to transfer heat by thermal conduction and thermal radiation with respect to the food product positioned on the at least one shelf; and moving, by the temperature-controlled air system, air through the chamber so as to transfer heat by thermal convection with respect to the food product positioned on the at least one shelf.

An advantage of the present invention is that it uses a temperature-controlled air system (heated or cooled) in conjunction with a temperature-controlled shelf system (heated or cooled) to maximize the heat transfer in or out of food product placed on the shelves. This can be used both to warm or to cool food products or to hold the food products at a desirable temperature. Heat transfer is maximized by using each of the following aspects of heat transfer: thermal conduction; thermal convection; and thermal radiation. The present invention advantageously uses shelf conduction and air convection to control food product temperature very accurately and to accelerate thaw times and to decrease warming times. Indeed, thawing times of food can be reduced substantially, for example, down to 18 hours.

Another advantage of the present invention is that it provides significant attention to airflow, air velocity, and temperature control, so as to effectuate an enhanced heat transfer with respect to the food product within the foodservice unit.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic perspective view of a temperature-controlled foodservice unit, which includes a body, a plurality of temperature-controlled systems (including a temperature-controlled shelf system and a temperature-controlled air system), and a control system, according to an exemplary embodiment of the present invention;

FIG. 2 is a schematic front view of the temperature-controlled foodservice unit of FIG. 1, with portions broken away, according to an exemplary embodiment of the present invention;

FIG. 3 is a perspective view of the temperature-controlled foodservice unit of FIG. 1, with portions broken away, according to an exemplary embodiment of the present invention;

FIG. 4 is a schematic diagram of fluid circuits of the temperature-controlled foodservice unit of FIG. 1, according to an exemplary embodiment of the present invention;

FIG. 5 is a schematic diagram of the control system of FIG. 1, according to an exemplary embodiment of the present invention; and

FIG. 6 is a flow diagram showing a method of using the temperature-controlled foodservice unit, in accordance with an exemplary embodiment of the present invention.

Corresponding reference characters indicate corresponding parts throughout the several views. The exemplifications set out herein illustrate an embodiment of the invention, and such exemplifications are not to be construed as limiting the scope of the invention in any manner.

### DETAILED DESCRIPTION OF THE INVENTION

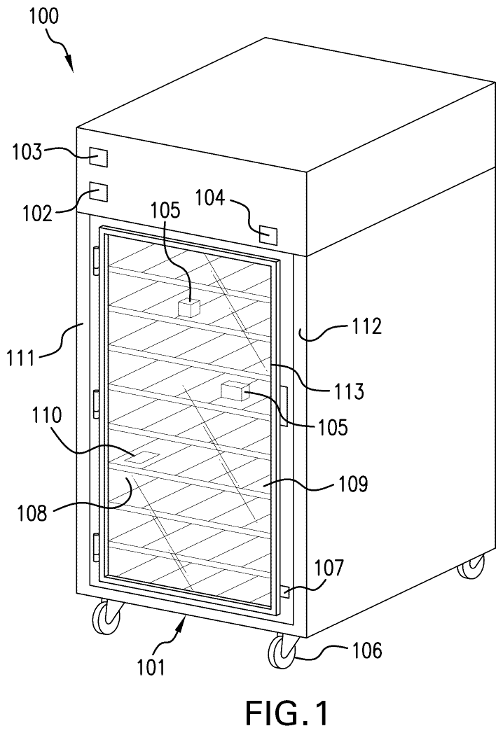

Referring now to the drawings, and more particularly to FIG. 1, there is shown a schematic perspective view of a temperature-controlled foodservice unit 100, according to an exemplary embodiment of the present invention (unit 100 according to each of the embodiments of the present invention described herein and/or shown in the drawings includes a variety of interconnected parts described herein). Unit 100 generally includes a body 101, a plurality of temperature-controlled systems 102, 103, and a control system 104 (control system 104 being shown schematically in FIG. 1 and discussed further below). Unit 100 is configured for servicing a plurality of food items 105 (which can also be referred to as food or food product), which includes (i) warming and cooking items 105, (ii) cooling items 105, and/or (iii) holding items 105 at a constant temperature. As shown in FIG. 1, according to an exemplary embodiment of the present invention, body 101 can be formed as a cabinet 101, which is assumed to be the case herein. Cabinet 101 includes a frame 107 (shown schematically in FIG. 1) and defines a chamber 108 inside cabinet 101, chamber 108 being where food items 105 are warmed, cooked, cooled, and/or held. As shown in FIG. 1, cabinet 101 can include a plurality of wheels 106, configured for enabling cabinet 101 to be wheeled across a floor. Cabinet 101 further includes a hinged door 113 providing a user accessibility to chamber 108 and items 105 therein.

Temperature-controlled systems 102, 103 (shown schematically in FIG. 1) are operatively coupled with frame 107 and are configured for transferring heat with respect to food product 105 positioned within chamber 108 (that is, heat is transferred to (warming) or away from (cooling) food product 105). Temperature-controlled systems 102, 103 include a temperature-controlled shelf system 102 and a temperature-controlled air system 103. Each of systems 102, 103 are configured for heating or cooling the respective medium of the respective system 102, 103 to a respective desired or target setpoint temperature. The desired setpoint temperatures of systems 102, 103 can be different and independent of each other.

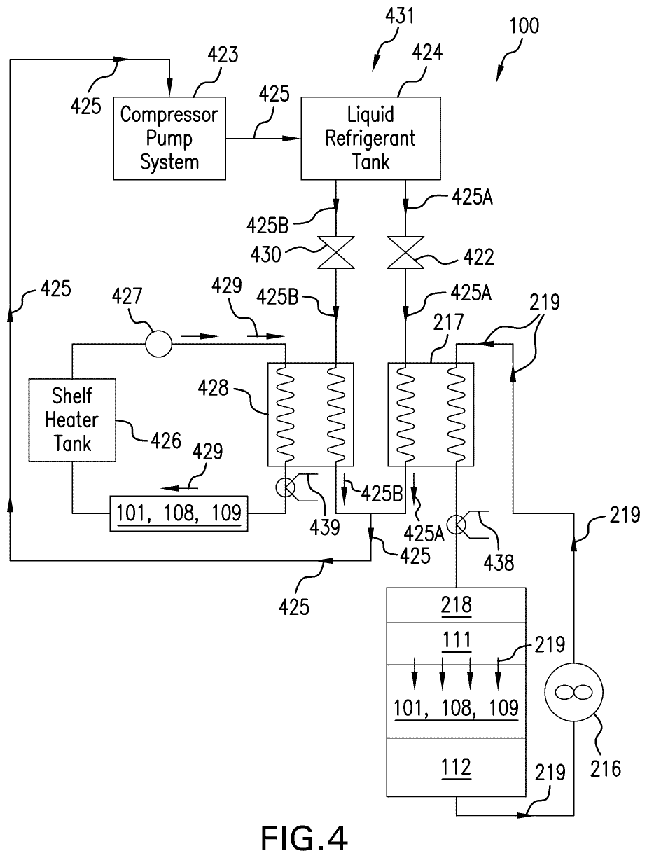

Temperature-controlled shelf system 102 forms a fluid circulation system and includes at least one shelf 109 (a plurality of shelves 109 being shown in FIG. 1) and at least one fluid passageway 110 (shown schematically in FIG. 1) (wherein, according to an exemplary embodiment of the present invention, the fluid is a liquid, which is assumed to be the case herein). Shelves 109 are positioned within chamber 108. The fluid which flows in fluid passageways 110 can be referred to herein as shelf fluid. Fluid passageways 110 are associated with (optionally, connected to or formed inside of) a respective shelf 109 and are configured for carrying the shelf fluid therein so as to transfer heat by thermal conduction and thermal radiation with respect to food product 105 positioned on shelves 109 (that is, heat is transferred to (warming) or away from (cooling) food product 105). Each shelf 109 can thus be referred to as a fluid shelf 109. Further, by way of temperature-controlled shelf system 103, the fluid in shelves 109 can be either heated or cooled to a desired setpoint with at least one fluid-heating device 426 to warm the shelf fluid and with a fluid-cooling device 428 that chills the shelf fluid, respectively (FIG. 4). Thus, shelves 109 are configured to transfer heat to or away from food product 105 by way of thermal conduction (depending upon whether warming or cooling of food product 105 is desired), because of the direct contact between shelves 109 and food product 105. Further, shelves 109 also radiate heat to food product 105 (above and below shelves 109) if shelves 109 are warmer than product 105 and the warming of food product 105 is desired, and shelves 109 absorb radiant heat if food product 105 is warmer than shelves 109 and the cooling of food product 105 is desired.

Temperature-controlled air system 103 forms an air circulation system and is configured for moving air through chamber 108 so as to transfer heat by thermal convection with respect to food product 105 positioned on shelves 109 (that is, heat is transferred to (warming) or away from (cooling) food product 105). Temperature-controlled air system 103 includes an air supply plenum 111 and an air return plenum 112. Air supply plenum 111 is configured for receiving air from other aspects of air system 103 and for supplying air to chamber 108. Air return plenum 112 is configured for receiving air from chamber 108 and for forwarding this air to other aspects of air system 103.

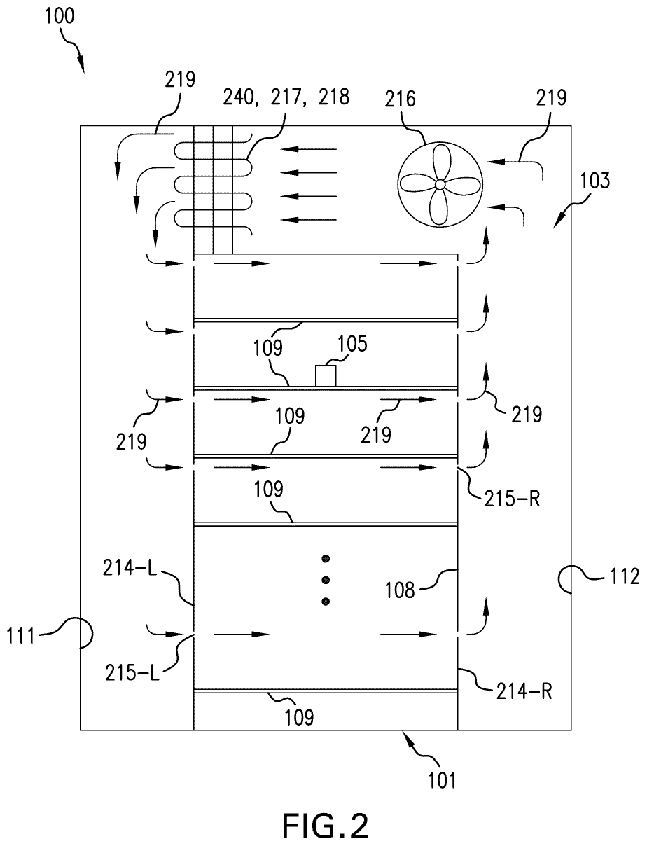

Referring now to FIG. 2, there is shown schematically a front view of unit 100, with portions broken away. FIG. 2 shows schematically temperature-controlled air system 103 but omits temperature-controlled shelf system 103. Unit 100 further includes side walls 214-L, 214-R opposing one another. Side walls 214-L, 214-R are parts of both cabinet 101 and air system 103; stated another way, each of cabinet 101 and air system 103 includes side walls 214-L, 214-R. More specifically, one surface of side wall 214-L faces chamber 108, and the other surface of side wall 214-L faces air supply plenum 111. Similarly, one surface of side wall 214-R faces chamber 108, and the other surface of side wall 214-R faces air return plenum 112. Each of side walls 214-L, 214-R includes a respective plurality of holes 215-L, 215-R. Holes 215-L are configured for allowing air to flow an interior of air supply plenum 111 to chamber 108, and holes 215-R are configured for allowing air to flow from chamber 108 to air return plenum 112. Holes 215-L, in cooperation with holes 215-R, are configured for directing the air flow over and around food product 105 in chamber 108.

Air system 103 provides an airflow system around body 101. According to an exemplary embodiment of the present invention, air system 103 further includes an air-moving device 216 and an air-treatment apparatus 240. Air-moving device 216 is configured for moving the air within temperature-controlled air system 103 and thereby for increasing or decreasing a velocity of the air or holding the velocity of the air constant. Air-moving device 216 can be, for example and not limitation, a fan or a (powerful) forced air blower, configured for recirculating the air. Air-treatment apparatus 240 is a heat exchanger, such as a radiator-type heat exchanger, that uses heated or cooled fluid to affect the temperature of the air flowing thereby (as indicated by airflow arrows 219). Air-treatment apparatus 240 is thus configured for (i) cooling the air before the air enters air supply plenum 111 and (ii) heating the air before the air enters air supply plenum 111. Air-treatment apparatus 240 can include an actuator (or, alternatively, such an actuator can be associated with apparatus 240) configured for metering and thus allowing passage of the heated or cooled fluid to other parts of apparatus 240, in order to control air temperature flowing within air system 103.

According to an alternative embodiment of the present invention (but still shown in FIG. 2), air system 103 includes an air-cooling device 217 and an air-heating device 218, rather than air-treatment apparatus 240 (which combines the air cooling and heating functions). In this embodiment, then, the same structure in FIG. 2 that is labeled as 240 is also labeled as 217, 218, but it is understood that this structure is either apparatus 240 or, alternatively, two separate devices 217, 218 (though devices 217, 218 can form parts of a unit (i.e., a chiller evaporator and heater unit) or be two separate parts not parts of a single unit). Air-cooling device 217 is configured for cooling the air before the air enters air supply plenum 111. Air-cooling device 217 can be, for example and not limitation, a chiller evaporator (which can also be described as an evaporator-type heat exchanger), a radiator, or an equivalent device that cools the air. Air-heating device 218 is configured for heating the air before the air enters air supply plenum 111. Air-heating device 218 can be any suitable heating device for heating air.

FIG. 2 shows with arrows 219 the direction of air flowing in air system 103. Thus, as indicated by airflow arrows 219, air is directed to flow, and thereby flows, into air supply plenum 111, then through holes 215L in wall 214-L, then over and around food product 105 on shelves 109 in chamber 108, then through holes 215-R of wall 214-R, then into air return plenum 112, then to and through air-moving device 216, which forces air onward to apparatus 240 (or air-cooling device 217/air-heating device 218), and then air is recirculated to air supply plenum 111. The number, size, and arrangement of holes 215-L, 215-R, together with the size of air-moving device 216, are optimized to achieve a desired airflow velocity and flow path of the air over and around food product 105. According to one application of the present invention, air-moving device 216 sucks air from one side of cabinet 101, the air then going through apparatus 240 (or, alternatively, an evaporator type coil of air-cooling device 217) to cool the air to—according to this application of the present invention—38 degrees Fahrenheit and is reintroduced to the other side of cabinet 101; according to this application, this air stream—which is held at 38 degrees Fahrenheit (+/−)—helps to thaw frozen food product 105 through convection and then to hold the temperature of food product 105 below 40 degrees Fahrenheit once thawed as cabinet door 113 is opened and closed. Further, FIG. 2 shows three vertical dots between the lowermost shelf 109 and the next higher shelf 109; these three vertical dots collectively signify a vertical ellipsis, thus communicating that more or less shelves 109 could be employed.

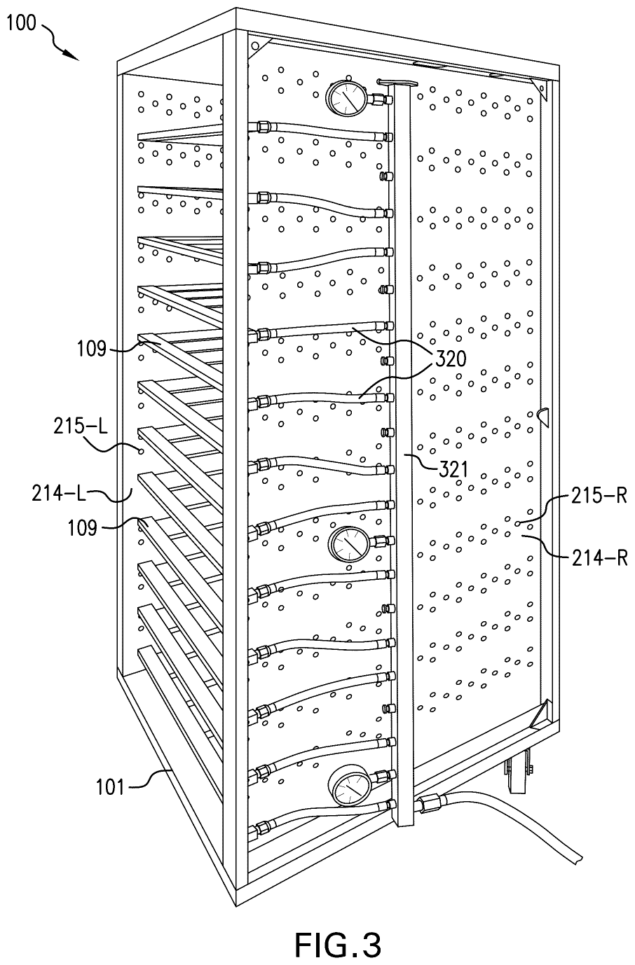

Referring now to FIG. 3, there is shown a perspective view of temperature-controlled foodservice unit 100, with portions broken away. FIG. 3 shows body 101, side walls 214-L, 214-R, holes 215-L, 215-R respectively in side walls 214-L, 214-R. FIG. 3 also shows a portion of temperature-controlled shelf system 102, which includes fluid lines 320 and a manifold 321 fluidly connected with and fluidly downstream of fluid lines 320; here, fluid lines 320 and manifold 321 are return fluid lines 320 and return manifold 321, which are fluidly downstream of shelves 109. Upstream of shelves 109, system 102 can similarly include supply fluid lines (not shown) and a supply manifold (not shown) fluidly coupled with and upstream of the supply fluid lines (not shown).

Referring now to FIG. 4, there is shown a schematic diagram of temperature-controlled foodservice unit, more specifically, a fluid (media) circuit diagram showing flow routes of various fluids circulating in unit 100 (that is, the air of air system 103, the shelf fluid of shelf system 102, and a liquid refrigerant of a refrigerant compressor system 431). FIG. 4 shows temperature-controlled foodservice unit 100, including cabinet 101, shelf system 102, and air system 103; the embodiment of the present invention shown in FIG. 4 is the embodiment described above that employs devices 217, 218, rather than apparatus 240. For the sake of clarity with respect to the various lines in FIG. 4, cabinet 101 (with chamber 108 and shelves 109) is shown twice, but it should be understood that only a single cabinet 101 (with chamber 108 and shelves 109) is contemplated as part of foodservice unit 100 in FIG. 4. According to an exemplary embodiment of the present invention, air system 103 is shown to include air supply plenum 111, air return plenum 112, air-moving device 216, air-cooling device 217, and air-heating device 218, with arrows 219 showing the direction of airflow. Air system 103 further includes an actuator 422 (which can be a solenoid valve 422), a thermal expansion valve (optionally) (not shown) associated with air-cooling device 217 (this thermal expansion valve can also be considered to be an actuator), a compressor pump system 423 (which is configured for pumping a liquid refrigerant), and a liquid refrigerant tank 424 (which is configured for receiving, holding, and dispensing the liquid refrigerant), with arrows 425 showing the direction of flow of the liquid refrigerant in conduits common between air system 103 and shelf system 102 and arrows 425A showing more specifically the direction of flow of the liquid refrigerant within conduits associated with air system 103 only. Solenoid valve 422 is configured for metering and thus allowing passage of the liquid refrigerant from liquid refrigerant tank 424 to air-cooling device 217, in order to control air temperature flowing within air system 103. Air system 103 further includes an air temperature sensor 438 (which can be a thermocouple), configured for sensing the temperature of the air within air system 103. Solenoid valve 422 is associated with air-cooling device 217; solenoid valve 422 can be spaced apart from or directly attached to air-cooling device 217.

Further, according to an exemplary embodiment of the present invention, shelf system 102 is shown to include shelves 109, a shelf heater tank 426 (configured for storing and/or heating the shelf fluid within shelf system 102), a pump 427 (configured for pumping the liquid within shelf system 102), a fluid-cooling device 428 (configured for cooling the liquid within shelf system 102), and a shelf fluid temperature sensor 439 (which can be a thermocouple) (configured for sensing the temperature of the shelf fluid within shelf system 102), with arrows 429 showing the direction of the flow of the shelf fluid in shelf system 102 (optionally, shelf system 102 can include a fluid reservoir configured for storing the shelf fluid therein, with the fluid reservoir being positioned at any suitable location in shelf system 102). Shelf system 102 further includes an actuator 430 (which can be a solenoid valve 430), a thermal expansion valve (optionally) (not shown) associated with fluid-cooling device 428 (this thermal expansion valve can also be considered to be an actuator), compressor pump system 423 (which is configured for pumping the liquid refrigerant), and liquid refrigerant tank 424 (which is configured for receiving, holding, and dispensing the liquid refrigerant), with arrows 425 showing the direction of flow of the liquid refrigerant in conduits common between air system 103 and shelf system 102 and arrows 425B showing more specifically the direction of flow of the liquid refrigerant within conduits associated with shelf system 102 only (compressor pump system 423 and liquid refrigerant tank 424 can be deemed to be parts of both shelf system 102 and air system 103). Solenoid valve 430 is configured for metering and thus allowing passage of the liquid refrigerant from liquid refrigerant tank 424 to fluid-cooling device 428, in order to control shelf fluid temperature flowing within shelf system 102. Solenoid valve 430 is associated with fluid-cooling device 428; solenoid valve 430 can be spaced apart from or directly attached to fluid-cooling device 428. Fluid-cooling device 428 can be any suitable type of heat exchanger, for example and not limitation, a liquid (liquid refrigerant) to liquid (fluid flowing through shelves 109) heat exchanger.

Unit 100 further includes refrigerant compressor system 431 (which circulates the liquid refrigerant), which includes solenoid valves 422, 430, compressor pump system 423, and liquid refrigerant tank 424. Refrigerant compressor system 431 is used to receive and to maintain reservoir tank 424 of the liquid refrigerant (which is a compressed refrigerant) that can be released as required by solenoid valves 422, 430 and/or the aforementioned thermal expansion valves (not shown) to achieve cooling with respect to the air flowing through air-cooling device 217 and the shelf fluid flowing through fluid-cooling device 428. With respect to air system 103, the air is monitored by air temperature sensor 438 in or near air supply plenum 111. When the air temperature rises above the setpoint (the desired air temperature) as detected by air temperature sensor 438, solenoid valve 422 is actuated by a controller 532 (which may be a single controller or a plurality of controllers) of control system 104, thereby allowing the liquid refrigerant to flow across air-cooling device 217 (or, alternatively, apparatus 240) to cool the air in air system 103. Similarly, with respect to shelf system 102, when the temperature of the shelf fluid-at the supply side of shelves 109—for shelves 109 rises above the setpoint (the desired shelf fluid temperature) as detected by shelf fluid temperature sensor 439, solenoid valve 430 is actuated by controller 532 of control system 104, thereby allowing the liquid refrigerant into heat exchanger 428 that cools the shelf fluid of shelf system 102.

Heating or cooling of both the air of air system 103 and the shelf fluid of shelf system 102 can be independently controlled to maintain the respective desired setpoints. When air temperature sensor 438 of air system 103 indicates the air is too cool, heating elements of air-heating device 218 can be turned on to warm the air to the desired setpoint. Similarly, the shelf fluid of shelf system 103 can also be warmed when the fluid temperature sensor 439 of shelf system 102 indicates the shelf fluid of shelf system 102 is too cool relative to the setpoint temperature of shelf system 102, wherein such warming can be accomplished in any suitable manner by way of shelf heater tank 426 (which can also be referred to as a fluid supply tank), such as by way of Cal rod type heaters in fluid supply tank 426.

Each of the following can be coupled with frame 107 and located at any suitable location with respect to frame 107: air-moving device 216; solenoid valve 422; air-cooling device 217; air-heating device 218; air-treatment apparatus 240 (according to an alternative embodiment); air temperature sensor 438; air supply plenum 111; air return plenum 112; shelf heater tank 426; pump 427; solenoid valve 430; fluid-cooling device 428; fluid temperature sensor 439; compressor pump system 423; liquid refrigerant tank 424; controller 532; and all medium-carrying lines or conduits (shown in FIG. 4 and associated with arrows 219, 429, 425, 425A, 425B) that are part of unit 100 and extend to, from, or between any or all of these structures. For example (and without limitation), air-moving device 216, solenoid valve 422, air-cooling device 217, air-heating device 218, shelf heater tank 426, pump 427, solenoid valve 430, fluid-cooling device 428, fluid temperature sensor 439, compressor pump system 423, and liquid refrigerant tank 424 may be located in a space of unit 100 above chamber 108. Further, if air-treatment device 240 is used instead of devices 217, 218, a fluid circuit diagram similar to what is shown in FIG. 4 can be used, with necessary adjustments being made.

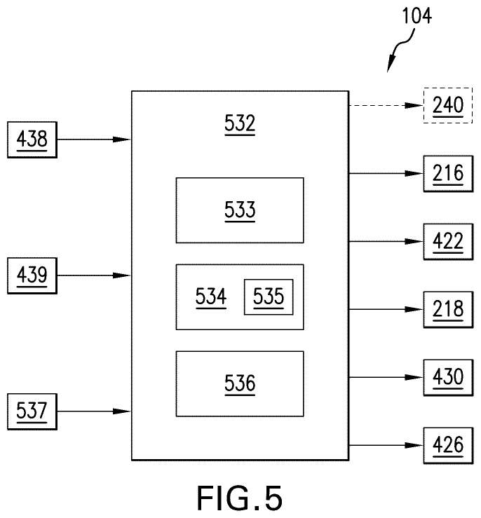

Referring now to FIG. 5, there is shown a schematic diagram of control system 104. As indicated above, unit 100 includes control system 104. Control system 104 includes a controller 532, which includes a processor 533, memory 534, data 535, and instructions 536. Control system 104 can further include an input/output device 537 such as a laptop computer (with keyboard and display) or a touchpad (including keypad functionality and a display), device 537 being configured for a user to interface therewith.

Further, in general, controller 532 may correspond to any suitable processor-based device(s), such as a computing device or any combination of computing devices. Controller 532 may generally include one or more processor(s) 533 and associated memory 534 configured to perform a variety of computer-implemented functions (e.g., performing the methods, steps, algorithms, calculations and the like disclosed herein). Thus, controller 532 may include a respective processor 533 therein, as well as associated memory 534, data 535, and instructions 536, each forming at least part of controller 532. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, memory 534 may generally include memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD), and/or other suitable memory elements. Such memory 534 may generally be configured to store information accessible to the processor(s) 533, including data 535 that can be retrieved, manipulated, created, and/or stored by the processor(s) 533 and the instructions 536 that can be executed by the processor(s) 533. In some embodiments, data 535 may be stored in one or more databases.

Controller 532 can communicate with any input devices (i.e., air temperature sensor 438, fluid temperature sensor 439) and output devices (i.e., air-moving device 216, air-heating device 218, actuator 422, actuator 430, shelf heater tank 426, air-treatment apparatus 240 (which is in broken lines to indicate that apparatus 240 can be an alternative embodiment of the present invention)), and any other controllers, in any suitable manner, such as a wired connection or a wireless connection, such as radio signals (RF), light signals, cellular, WiFi, Bluetooth, Internet, via cloud-based devices such as servers, and/or the like. Further, while not shown, controller 532 can communicate with a remotely located data center, which controller 532 can communicate with by any suitable way, such as those just referenced. Such a data center can include its own controller (and thus processor(s), memory, data, and instructions, substantially similar to that described above with respect to controller 532) which can be configured to perform any of the functions associated with controller 532. Controller 532 and the data center can be a part of any network facilitating such communication therebetween, such as a local area network, a metropolitan area network, a wide area network, a neural network, whether wired or wireless. Further, it is assumed herein that controller 532 is coupled with frame 107 (and thus on board unit 100), but alternatively controller 532 can be located off-site from frame 107 in a remote location.

Control system 104 is operatively coupled with shelf system 102 and air system 103. Control system 104 includes: (a) air temperature sensor 438 which is configured for: (i) sensing an air temperature of the air in temperature-controlled air system 103; and (ii) outputting an air temperature signal corresponding to the air temperature that is sensed; and (b) controller 532 which is configured for: (i) receiving the air temperature signal; (ii) determining, based at least in part on the air temperature signal and a target (desired, setpoint) air temperature, an air temperature adjustment; and (iii) outputting, based at least in part on the air temperature adjustment, an air temperature adjustment signal to air-moving device 216 (for example, air velocity in air system 103 an be controlled), actuator 422, air-heating device 218, and/or air-treatment apparatus 240. Control system 104 further includes: (a) fluid temperature sensor 439 which is configured for: (i) sensing a fluid temperature of the shelf fluid in shelf system 102; and (ii) outputting a fluid temperature signal corresponding to the fluid temperature that is sensed; and (b) controller 532 which is configured for: (i) receiving the fluid temperature signal; (ii) determining, based at least in part on the fluid temperature signal and a target (desired, setpoint) shelf fluid temperature of the shelf fluid of shelf system 102, a fluid temperature adjustment; and (iii) outputting, based at least in part on the fluid temperature adjustment, a fluid temperature adjustment signal to actuator 430 and/or fluid-heating device 426. Further, control system 104 is configured for maintaining the air temperature of the air in air system 103 and the shelf fluid temperature of the shelf fluid in shelf system 102 independently of one another (or, alternatively, in consideration of one another) in accordance with the target air temperature of the air of air system 103 and the target shelf fluid temperature of the shelf fluid if shelf system 102, respectively.

In use, a user can place food product 105 on shelves 109 of unit 100. Unit 100 can be powered for instance by electrical power, and user can thereby electrically power unit 100. By way of input/output device 537, user can set the target air temperature of the air of air system 103 and the target shelf fluid temperature of the shelf fluid of shelf system 102. Thus, sensors 438, 439 respectively sense the air temperature and shelf fluid temperature and provide this data to controller 532. Depending upon what adjustments need to be made so that the actual air temperature sensed by air temperature sensor 438 and the actual shelf fluid temperature sensed by fluid temperature sensors 439, controller 532 can output adjustment signals to solenoid valve 422 and/or solenoid valve 430 so that the actual air temperature matches the target air temperature and the actual shelf fluid temperature matches the target shelf fluid temperature. In this way, heating or cooling of food product 105 or maintenance of the temperature of food product 105 can be accomplished. Such heat transfer is thus accomplished efficiently, using thermal conduction, thermal radiation, and thermal convection.

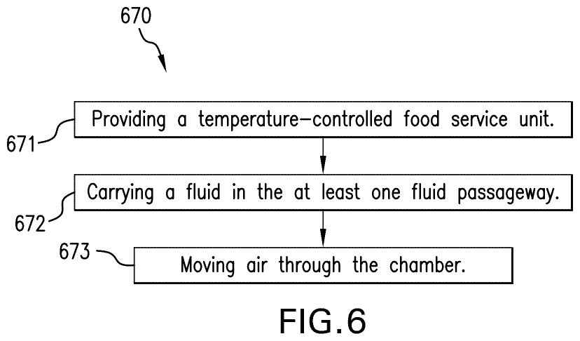

Referring now to FIG. 6, there is shown a flow diagram showing a method 670 of using a temperature-controlled foodservice unit 100. Method 670 includes the steps of: providing 671 that the temperature-controlled foodservice unit 100 includes a body 101 and a plurality of temperature-controlled systems 102, 103, the body 101 including a frame 107 and defining a chamber 108, the plurality of temperature-controlled systems 102, 103 being operatively coupled with the frame 107 and configured for transferring heat with respect to a food product 105 positioned within the chamber 108, the plurality of temperature-controlled systems 102, 103 including a temperature-controlled shelf system 102 and a temperature-controlled air system 103, the temperature-controlled shelf system 102 including at least one shelf 109 and at least one fluid passageway 110, the at least one shelf 109 being positioned within the chamber 108, the at least one fluid passageway 110 being associated with the at least one shelf 109; carrying 672, by the at least one fluid passageway 110, a fluid in the at least one fluid passageway 110 so as to transfer heat by thermal conduction and thermal radiation with respect to the food product 105 positioned on the at least one shelf 109; and moving 673, by the temperature-controlled air system 103, air through the chamber 108 so as to transfer heat by thermal convection with respect to the food product 105 positioned on the at least one shelf 109. Temperature-controlled air system 103 can include an air supply plenum 111 and an air return plenum 112, the air supply plenum 111 including a first wall 214-L with a first plurality of holes 215-L, the air return plenum 112 including a second wall 214-R with a second plurality of holes 215-R. Temperature-controlled air system 103 can include an air-moving device 216 configured for moving the air within the temperature-controlled air system 103 and thereby for increasing or decreasing a velocity of the air. Temperature-controlled air system 103 can include: (a)(i) an air-cooling device 217 configured for cooling the air before the air enters the air supply plenum 111 and (ii) a first actuator 422 associated with the air-cooling device 217; or (b) an air-treatment apparatus 240 configured for cooling the air before the air enters the air supply plenum 111. Temperature-controlled air system 103 can include: (a) an air-heating device 218 configured for heating the air before the air enters the air supply plenum 111; or (b) the air-treatment apparatus 240 configured for heating the air before the air enters the air supply plenum 111. Temperature-controlled shelf system 102 can include a fluid-cooling device 428 configured for cooling the fluid and a fluid-heating device 426 configured for heating the fluid. Temperature-controlled air system 103 can further include a control system 104 operatively coupled with the temperature-controlled shelf system 102 and the temperature-controlled air system 103, the control system including: (a) a first sensor 438 configured for: (i) sensing an air temperature of the air in the temperature-controlled air system 103; and (ii) outputting an air temperature signal corresponding to the air temperature that is sensed; and (b) a controller 532 configured for: (i) receiving the air temperature signal; (ii) determining, based at least in part on the air temperature signal, an air temperature adjustment; and (iii) outputting, based at least in part on the air temperature adjustment, an air temperature adjustment signal to at least one of the air-moving device 216, the first actuator 422, the air-heating device 218, and air-treatment apparatus 240. Temperature-controlled shelf system 102 can further include a second actuator 430 associated with the fluid-cooling device 428, wherein the control system 104 includes: (a) a second sensor 439 configured for: (i) sensing a fluid temperature of the shelf fluid in the temperature-controlled shelf system 102; and (ii) outputting a fluid temperature signal corresponding to the fluid temperature that is sensed; and (b) the controller configured for: (i) receiving the fluid temperature signal; (ii) determining, based at least in part on the fluid temperature signal, a fluid temperature adjustment; and (iii) outputting, based at least in part on the fluid temperature adjustment, a fluid temperature adjustment signal to at least one of the second actuator 430 and the fluid-heating device 426. Control system 104 can be configured for maintaining the air temperature of the air in the temperature-controlled air system 103 and the fluid temperature of the shelf fluid in the temperature-controlled shelf system 102 independently of one another in accordance with a target air temperature and a target fluid temperature, respectively.

It is to be understood that the steps of method 670 are performed by controller 532 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by controller 532 described herein, such as the method 670, is implemented in software code or instructions which are tangibly stored on a tangible computer readable medium. The controller 532 loads the software code or instructions via a direct interface with the computer readable medium or via a wired and/or wireless network. Upon loading and executing such software code or instructions by controller 532, controller 532 may perform any of the functionality of controller 532 described herein, including any steps of the method 670.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A temperature-controlled foodservice unit, comprising:
a body including a frame and defining a chamber; and
a plurality of temperature-controlled systems operatively coupled with the frame and configured for transferring heat with respect to a food product positioned within the chamber, the plurality of temperature-controlled systems including:
a temperature-controlled shelf system including at least one shelf and at least one fluid passageway, the at least one shelf being positioned within the chamber, the at least one fluid passageway being associated with the at least one shelf and configured for carrying a fluid therein so as to transfer heat by thermal conduction and thermal radiation with respect to the food product positioned on the at least one shelf; and
a temperature-controlled air system configured for moving air through the chamber so as to transfer heat by thermal convection with respect to the food product positioned on the at least one shelf.

2. The temperature-controlled foodservice unit according to claim 1, wherein the temperature-controlled air system includes an air supply plenum and an air return plenum, the air supply plenum including a first wall with a first plurality of holes, the air return plenum including a second wall with a second plurality of holes.

3. The temperature-controlled foodservice unit according to claim 2, wherein the temperature-controlled air system includes an air-moving device configured for moving the air within the temperature-controlled air system and thereby for increasing or decreasing a velocity of the air.

4. The temperature-controlled foodservice unit according to claim 3, wherein the temperature-controlled air system includes:
(a)(i) an air-cooling device configured for cooling the air before the air enters the air supply plenum and (ii) a first actuator associated with the air-cooling device; or
(b) an air-treatment apparatus configured for cooling the air before the air enters the air supply plenum.

5. The temperature-controlled foodservice unit according to claim 4, wherein the temperature-controlled air system includes:
(a) an air-heating device configured for heating the air before the air enters the air supply plenum; or
(b) the air-treatment apparatus configured for heating the air before the air enters the air supply plenum.

6. The temperature-controlled foodservice unit according to claim 5, wherein the temperature-controlled shelf system includes a fluid-cooling device configured for cooling the fluid and a fluid-heating device configured for heating the fluid.

7. The temperature-controlled foodservice unit according to claim 6, further comprising a control system operatively coupled with the temperature-controlled shelf system and the temperature-controlled air system, the control system including:
a first sensor configured for:
sensing an air temperature of the air in the temperature-controlled air system;
outputting an air temperature signal corresponding to the air temperature that is sensed;
a controller configured for:
receiving the air temperature signal;
determining, based at least in part on the air temperature signal, an air temperature adjustment;
outputting, based at least in part on the air temperature adjustment, an air temperature adjustment signal to at least one of the air-moving device, the first actuator, the air-heating device, and the air-treatment apparatus.

8. The temperature-controlled foodservice unit according to claim 7, wherein the temperature-controlled shelf system further includes a second actuator associated with the fluid-cooling device, wherein the control system includes:
a second sensor configured for:
sensing a fluid temperature of the fluid in the temperature-controlled shelf system;
outputting a fluid temperature signal corresponding to the fluid temperature that is sensed;
the controller configured for:
receiving the fluid temperature signal;
determining, based at least in part on the fluid temperature signal, a fluid temperature adjustment;
outputting, based at least in part on the fluid temperature adjustment, a fluid temperature adjustment signal to at least one of the second actuator and the fluid-heating device.

9. The temperature-controlled foodservice unit according to claim 8, wherein the control system is configured for maintaining the air temperature of the air in the temperature-controlled air system and the fluid temperature of the fluid in the temperature-controlled shelf system independently of one another in accordance with a target air temperature and a target fluid temperature, respectively.

10. A method of using a temperature-controlled foodservice unit, the method comprising the steps of:
providing that the temperature-controlled foodservice unit includes a body and a plurality of temperature-controlled systems, the body including a frame and defining a chamber, the plurality of temperature-controlled systems being operatively coupled with the frame and configured for transferring heat with respect to a food product positioned within the chamber, the plurality of temperature-controlled systems including a temperature-controlled shelf system and a temperature-controlled air system, the temperature-controlled shelf system including at least one shelf and at least one fluid passageway, the at least one shelf being positioned within the chamber, the at least one fluid passageway being associated with the at least one shelf;
carrying, by the at least one fluid passageway, a fluid in the at least one fluid passageway so as to transfer heat by thermal conduction and thermal radiation with respect to the food product positioned on the at least one shelf; and
moving, by the temperature-controlled air system, air through the chamber so as to transfer heat by thermal convection with respect to the food product positioned on the at least one shelf.

11. The method according to claim 10, wherein the temperature-controlled air system includes an air supply plenum and an air return plenum, the air supply plenum including a first wall with a first plurality of holes, the air return plenum including a second wall with a second plurality of holes.

12. The method according to claim 11, wherein the temperature-controlled air system includes an air-moving device configured for moving the air within the temperature-controlled air system and thereby for increasing or decreasing a velocity of the air.

13. The method according to claim 12, wherein the temperature-controlled air system includes:
(a)(i) an air-cooling device configured for cooling the air before the air enters the air supply plenum and (ii) a first actuator associated with the air-cooling device; or
(b) an air-treatment apparatus configured for cooling the air before the air enters the air supply plenum.

14. The method according to claim 13, wherein the temperature-controlled air system includes:
(a) an air-heating device configured for heating the air before the air enters the air supply plenum; or
(b) the air-treatment apparatus configured for heating the air before the air enters the air supply plenum.

15. The method according to claim 14, wherein the temperature-controlled shelf system includes a fluid-cooling device configured for cooling the fluid and a fluid-heating device configured for heating the fluid.

16. The method according to claim 15, further comprising a control system operatively coupled with the temperature-controlled shelf system and the temperature-controlled air system, the control system including:
a first sensor configured for:
sensing an air temperature of the air in the temperature-controlled air system;
outputting an air temperature signal corresponding to the air temperature that is sensed;
a controller configured for:
receiving the air temperature signal;
determining, based at least in part on the air temperature signal, an air temperature adjustment;
outputting, based at least in part on the air temperature adjustment, an air temperature adjustment signal to at least one of the air-moving device, the first actuator, the air-heating device, and the air-treatment apparatus.

17. The method according to claim 16, wherein the temperature-controlled shelf system further includes a second actuator associated with the fluid-cooling device, wherein the control system includes:
a second sensor configured for:
sensing a fluid temperature of the fluid in the temperature-controlled shelf system;
outputting a fluid temperature signal corresponding to the fluid temperature that is sensed;
the controller configured for:
receiving the fluid temperature signal;
determining, based at least in part on the fluid temperature signal, a fluid temperature adjustment;
outputting, based at least in part on the fluid temperature adjustment, a fluid temperature adjustment signal to at least one of the second actuator and the fluid-heating device.

18. The method according to claim 17, wherein the control system is configured for maintaining the air temperature of the air in the temperature-controlled air system and the fluid temperature of the fluid in the temperature-controlled shelf system independently of one another in accordance with a target air temperature and a target fluid temperature, respectively.
